(19) United States
(12) Patent Application Publication
(10) Pub. No.: US 2026/0048552 A1
(43) Pub. Date: Feb. 19, 2026

(54) METHOD AND SYSTEM FOR HIGH RESOLUTION 3D PRINTING USING AXIAL SCANNING

(71) Applicant: National Research Council of Canada, Ottawa (CA)

(72) Inventors: Antony ORTH, Ottawa (CA); Michel PICARD, Orleans (CA)

(21) Appl. No.: 19/103,954

(22) PCT Filed: Aug. 16, 2023
(86) PCT No.: PCT/CA2023/051086

§ 371 Date: Feb. 14, 2025

Related U.S. Application Data
(60) Provisional application No. 63/398,613, filed on Aug. 17, 2022.

(51) Int. Cl. B29C 64/393; B29C 64/129; B29C 64/241; B29C 64/255; B33Y 10/00; B33Y 30/00; B33Y 50/02

(52) U.S. Cl. CPC B29C 64/393; B29C 64/129; B29C 64/241; B29C 64/255; B33Y 10/00; B33Y 30/00; B33Y 50/02

(57) ABSTRACT

A method for additive manufacturing of an object having a three-dimensional structure formed from a photo-curable material, the method implemented by a computing device comprising a processor and a computer readable medium having instructions executable by the processor, the method comprising at least the steps of: (a) rotating a vial containing the photo-curable material in a path of a light beam at a predefined rotation speed; (b) calculating patterns associated with a 3D geometry of the object; (c) modulating a focal length of the beam within the photo-curable material while projecting the beam comprising the patterns into the photo-curable material to form the object.

### FIELD

Aspects of the disclosure relate to methods and systems for additive manufacturing, more specifically they relate to tomographic additive manufacturing.

### BACKGROUND

The design of unique chemistries and innovative printing approaches for photocurable additive manufacturing have led to developments in material design, functionality, and print speed [1-10]. These recent advances in light-based additive manufacturing have advanced the field beyond the traditional serial layer-by-layer fabrication approach. Tomographic additive manufacturing is one of these new techniques which recasts additive manufacturing as a tomographic projection problem [11-13]. In this approach, 2D light patterns are projected through a cylindrical vial containing a photopolymerizable resin, as shown in FIG. 1a. The projections are updated as the vial is made to rotate around its axis using a rotation stage; and the projections are chosen so that the total accumulated dose profile will define the desired object. When a voxel of resin absorbs a threshold light dose, the resin polymerizes into a solid. After a sufficient integer number of rotations, the absorbed light dose induces polymerization within a 3D region that corresponds to the desired object geometry.

One of the advantages of tomographic printing is the elimination of mechanical overhead of the layer-based system, which results in increased print speed and reduced hardware complexity. Although the mechanics of tomographic printing are simplified, the optical considerations are more complex than layer-based systems, where light is projected onto a planar air/resin interface. In tomographic additive manufacturing systems, the resin is contained in a cylindrical glass vial. Consequently, projected light patterns must travel through the curved vial surface to reach the resin. If the vial is in air, this curved refractive index interface acts as a strong, non-paraxial lens that severely distorts the projected light pattern.

Light-based additive manufacturing techniques enable a rapid transition from object design to production. In these approaches, a 3D object is typically built by successive polymerization of 2D layers in a photocurable resin. A recently demonstrated technique, however, uses tomographic dose patterning to establish a 3D light dose distribution within a cylindrical glass vial of photoresin. Lensing distortion from the cylindrical vial is currently mitigated by either an index matching bath around the print volume or a cylindrical lens.

In addition, in these techniques the resolution in tomographic additive manufacturing resolution is compromised due to the laws of physics. In more detail, in order to achieve high resolution, a narrow, perfectly collimated light beam in the resin would be required. However, any beam will spread due to diffraction, which results in shallow depth of field, and the beam spread deteriorates the resolution at edge of print volume (best achieved ˜0.1mm). Even worse, the beam spread increases as the beam is focused down.

### SUMMARY

In one of its aspects, a method for additive manufacturing of an object having a three-dimensional structure formed from a photo-curable material, the method implemented by a computing device comprising a processor and a computer readable medium having instructions executable by the processor, the method comprising at least the steps of:
(a) rotating a vial containing the photo-curable material in a path of a light beam at a predefined rotation speed;
(b) calculating patterns associated with a 3D geometry of the object;
(c) modulating a focal length of the beam within the photo-curable material while projecting the beam comprising the patterns into the photo-curable material to form the object.

In another of its aspects, there is provided a system for additive manufacturing of an object having a three-dimensional structure formed from a photo-curable material, the system comprising:
a computing device comprising a processor and a computer readable medium having instructions executable by the processor, wherein the processor is caused to at least:
(a) rotate a stage supporting a vial containing the photo-curable material in a path of a light beam at a predefined rotation speed;
(b) modulate a focal length of the beam within the photo-curable material; and
(c) project patterns associated with a 3D geometry of the object into the photo-curable material to form the object.

Advantageously, modulating the focal length at a particular frequency, or axial beam scanning, creates a time-averaged beam that minimizes beam spread, and results in a beam width that is uniform over scan range, such that the resolution is substantially uniform. The beam can be scanned by either inserting a tunable lens (TL) in the beam path or by translating an objective lens or the resin back and forth at a particular rate. In addition, the method and system allows for an increased number of voxels in the write volume, which results in higher resolution printed objects. Furthermore, the method and system are capable of microscale 3D printing which is substantially less expensive (by approximately 10-20 times) and substantially faster (by approximately 10⁶ times) compared to direct laser writing (DLW) techniques.

### BRIEF DESCRIPTION OF THE DRAWINGS

Several exemplary embodiments of the present disclosure will now be described, by way of example only, with reference to the appended drawings in which:

FIG. 1a shows an overhead schematic of a standard index-matched tomographic 3D printing setup, in which a projector projects patterns through a vial which is immersed in an index matching fluid (IMF);

FIG. 1b shows a perspective view of the standard index-matched tomographic 3D printing setup of FIG. 1a;

FIG. 2a shows exemplary frame images of an exemplary object to be generated;

FIG. 2b shows an exemplary generated object;

FIG. 3 shows an overhead schematic of an index-matched tomographic 3D printing setup employing axial beam scanning, in one example;

FIG. 4 shows a time-averaged shape of a static beam and an axially-scanned beam at various axial displacement distances (z) within the resin;

FIG. 5 shows a number of voxels at different beam widths corresponding to the beam width compared to prior art methods;

FIG. 6 shows the beam focus and resolution of an image using a prior art method and system;

FIG. 7 shows the beam focus and resolution of an image using the method and system of the instant application; and

FIG. 8 shows an exemplary computing system.

### DETAILED DESCRIPTION OF EXEMPLARY EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Moreover, it should be appreciated that the particular implementations shown and described herein are illustrative of the invention and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In tomographic additive manufacturing, a series of 2D light patterns is projected sequentially in time such that the integrated light dose in the cylindrical resin volume approximates the target light dose pattern. The simplest case is realized when light rays forming the projections travel parallel to each other through the resin, the so-called parallel beam geometry. Generally, this geometry is unphysical due to diffraction effects and the finite etendue of the projection system [12]. It is generally assumed that each pixel in the projector projects a non-diverging beam through the resin.

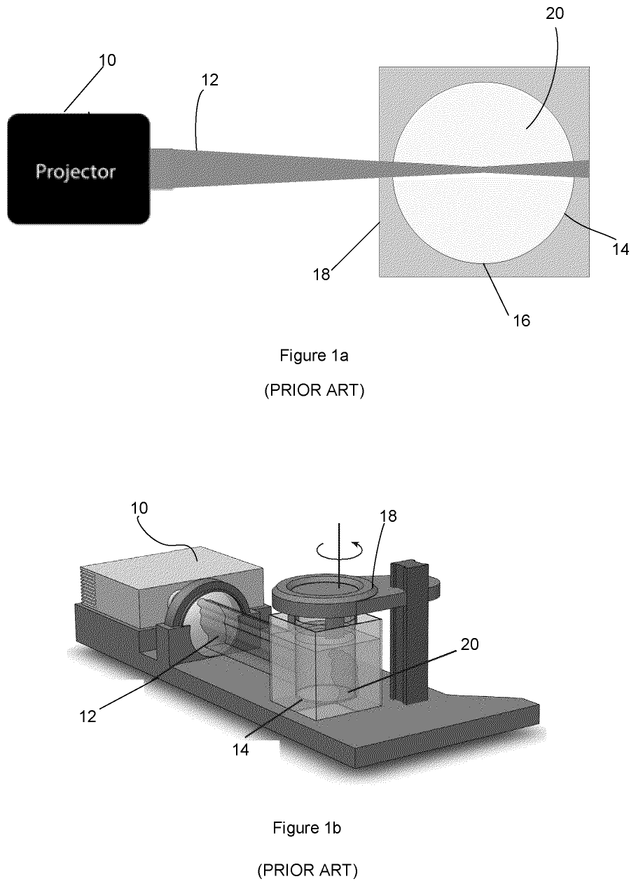

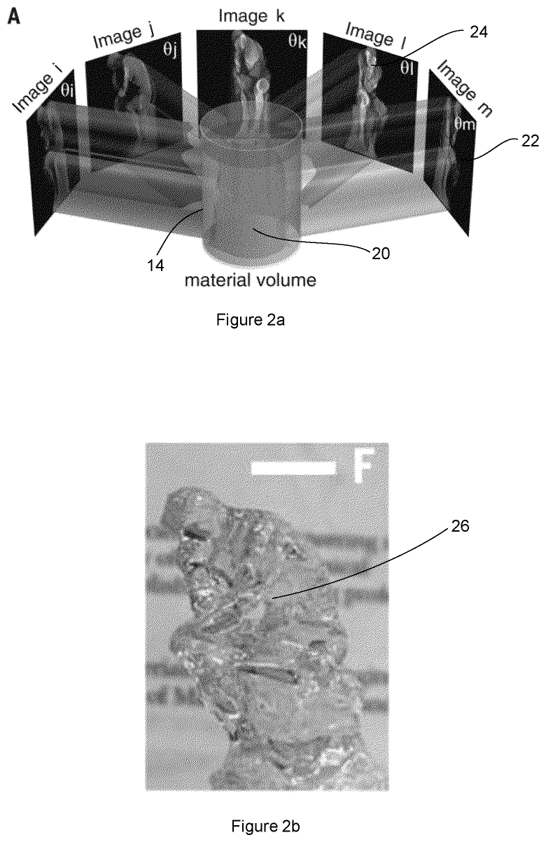

FIGS. 1a and 1b show a prior art index-matched tomographic 3D printing setup comprising a projector 10 that projects patterns 12 through a vial 14 which is immersed in an index matching fluid (IMF) 16. The vial 14 is placed on a rotation stage 18 that rotates at an angular rotation rate (Ω). 2D light patterns 12 are projected through the vial 14 containing a photo-curable material 20, such as a photopolymerizable resin. The light patterns 12 are calculated such that the total accumulated dose profile will define a desired object 22 to be printed. Accordingly, the projections 12 are updated as the vial 14 is made to rotate around its axis using the rotation stage 18. When a voxel of resin 20 absorbs a threshold light dose, the resin 20 polymerizes into a solid. After a sufficient integer number of rotations, the absorbed light dose induces polymerization within a 3D region that corresponds to the desired object geometry. FIG. 2a shows exemplary frame image2 of an exemplary object 24 to be generated, and FIG. 2b shows an exemplary generated object 26.

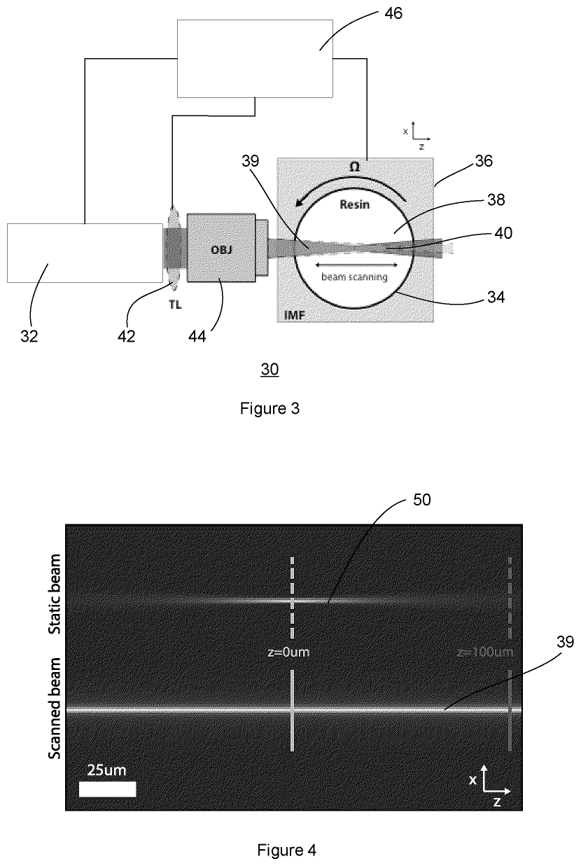

Looking at FIG. 3, there is shown an additive manufacturing system 30 comprising a light source 32, such as a projector, a container 34 placed on a rotation stage 36. The container 34 holds a resin 38 which receives a beam 39 with light patterns 40 corresponding to an object to be manufactured via an electrically-addressable optical element 42 and an optics system 44. A controller 46 synchronizes the rotation of the stage 36, generation of light patterns 40 and axial displacement of the electrically-addressable optical element 42.

In one example, a borosilicate scintillation vial 34 (n≈1.52, nominal diameter 25.4 mm) was filled with resin 38 (n₂≈1.53) and placed on a rotation stage 18, such as an M-060. PD precision rotation stage from Physik Instrumente (PI) GmbH & Co. KG. Germany, located at a predetermined distance from the optics system 44. In this example, projector 32 is a CEL5500 projector from Digital Light Innovations Inc., U.S.A. with a 460 nm light emitting diode light source is used. The maximum intensity at the focal plane was measured to be 3.8 mW/cm² (grayscale value=255), and the intensity was verified to be linear with grayscale value. The projector 32 has W=1024 pixels in the horizontal direction, and a manufacturers specification of Tr=1.8, resulting in a maximum CRA of φₜ=15.5° at the edge of the projection field.

The resin 38 was prepared similarly to that reported previously in literature [11]. Two acrylate crosslinkers were used as the precursor materials: bisphenol A glycerolate (1 glycerol/phenol) diacrylate [BPAGDA] and poly(ethylene glycol) diacrylate Mn 250 g/mol [PEGDA250] in a ratio of 3:1. To this BPAGDA/PEGDA250 mixture, the two component photoinitiator system, camphorquinone [CQ] and ethyl 4-dimethylaminobenzoate [EDAB], was added in a 1:1 weight ratio and CQ at a concentration of 7.8 mM in the resin 20. The concentration of the photoinitiators was adjusted to this value such that the penetration depth of the resin 38 was in-line with the radius of the vial 34. The resin 38 was mixed using a planetary mixer at 2000 rpm for 20 min followed by 2200 rpm for 30 sec, then separated into 20 mL scintillation vials (filled to ˜15 mL), for use in tomographic printing. The resin 38 was kept in a fridge for storage and allowed to warm to room temperature before use.

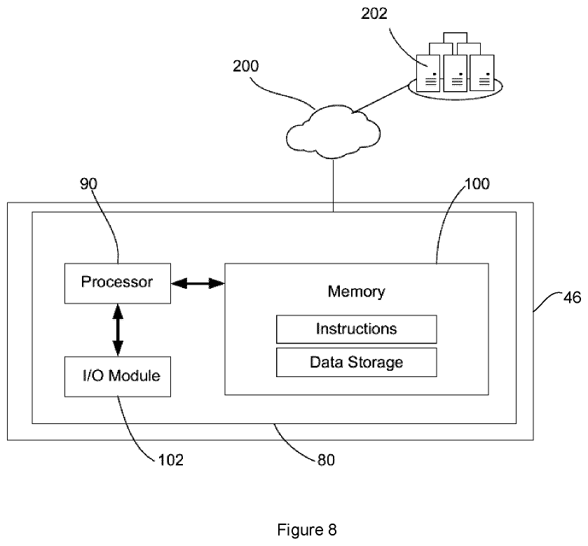

As can be seen in FIG. 8, the controller 46 may include one or more processors 90, a memory 100 for storing instructions, and an interface 102 for inputting/receiving various parameters and instructions for the controller 46. In various embodiments, controller 46 may have a database for storing any suitable information related to the additive manufacturing process. For example, database may store computer-aided design (CAD) files representing the geometry of a 3D object.

Prior to projection, the vial position in the projector field is located by scanning a line through the vial. During this calibration scan, a camera, such as the FLIR GS3-U3-32S4M-C camera from Edmund Optics Inc., U.S.A., with c-mount lens e.g. 25 mm/F1.8 #86572 from Edmund Optics Inc., U.S.A.), oriented perpendicular to the projection axis, images the vial 14. When the scan line encounters the edge of the vial, the photoinitiator in the resin absorbs projected light and emits fluorescence. This fluorescence is captured by the camera. The apparent edges of the write volume are located by finding the scan line positions for which there is a large.

After completing the calibration procedure, projections are calculated for the desired printobject. In one example, embossed geometries are created, in which 3D models are created directly as NumPy arrays in Python, followed by a Radon transform and ramp filtering for both the disc and embossed layers. For complex geometries, a custom Python script is used to import, slice and rasterize an STL file representing the object [14 ].

In one example, graphics processing unit (GPU) acceleration was implemented to speed up Radon transform calculation and ramp filtering of projections for the entire object [15, 16]. The calculated projections are then multiplied by a scalar factor between 1-2 to increase print speed if desired. The python script is run and causes the processor to send the projections to the projector 32, which displays the projections at a predetermined frame rate (n frames per second (fps)).

The rotation stage 18 is set to rotate at ω=10°/s; the beginning of rotation and projection display are software synchronized in the python script. After an integral number of rotations, the projection sequence terminates, and the rotation stage 18 stops. Typical print times were between 2.4-4.8 minutes (4-8 full rotations). In one example, the beam is scanned quickly back and forth to create a time-averaged beam which is substantially collimated, and therefore such axial beam scanning minimizes the spread of the beam. As such, the resulting beam width is uniform over the scan range, and the resolution is uniform.

In one example, axial beam scanning is performed by an electrically addressable optical element 42, such as a tunable lens (TL), in the focal plane which is used to modify the position of the object plane. For example, the axial displacement of the focus plane is determined as a function of the actuation voltage of the tunable lens 42, and therefore axial scanning is possible without mechanical displacement or movement of components, therefore vibrations due to such displacement or movement are substantially minimized. Alternatively, a time-averaged collimated beam 39 may also be achieved by rapid translation of the objective lens or the resin container at a predefined axial scanning rate.

FIG. 4 shows a time-averaged shape of a static beam 50 generated via a prior art method, and a time-averaged shape axially-scanned beam 39 at various axial displacement distances (z) within the resin 18 in one exemplary implementation. As can be seen, the static beam 50 is focused at z=0 μm and diverges before and after the focal point. In contrast, the scanned beam 39 is substantially uniform at the focal point (z=0 μm), including before and after the focal point.

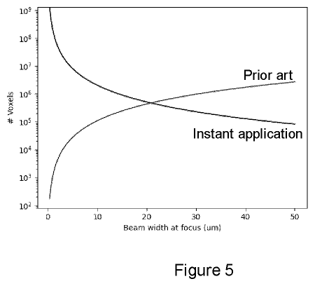

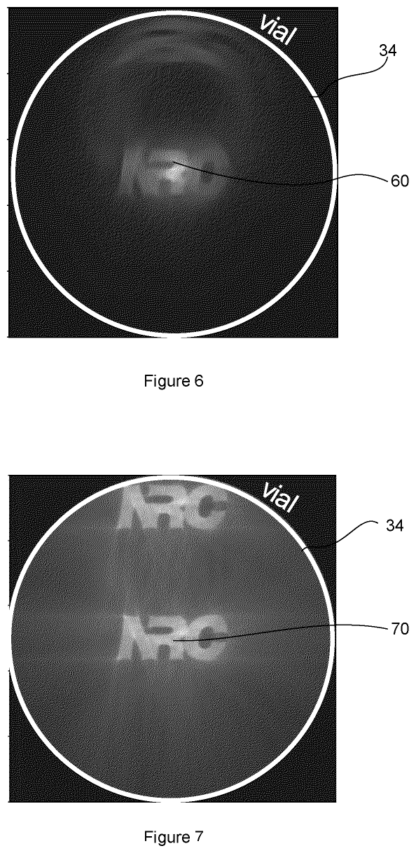

FIG. 5 shows the number of voxels at different beam widths corresponding to the beam width compared to prior art methods. As can be seen, the number of voxels is greatest for narrow beam widths and decreases as the beam width increases. FIG. 6 shows the beam focus and resolution of an object 60 using a prior art method and system; and FIG. 7 shows the beam focus and resolution of an object 70 using the method and system of the instant application.

After printing, the vial 14 is removed from the stage 18, and the printed object is removed from the vial 14, and uncured resin is removed by wiping with a delicated task wiper, such as a Kimwipe from Kimberly Clark Corporation, U.S.A. Final curing is achieved by placing the print in a Formlabs curing box for 120 minutes at 75° C. Height maps of the cured objects are acquired using an optical profiler, such as the CT100 optical profiler from Cyber Technologies GmBH., Germany, with an in-plane sampling period of 50 μm and 5 μm for low-and high-resolution heigh maps, respectively.

Referring to FIG. 8, the controller 46 includes a computing device 80 configured to perform the method as described herein. The term computing device refers to data processing hardware and encompass all kinds of apparatus, devices, and machines for processing data, including by way of example, a programmable processor, a computer, or multiple processors or computers. The apparatus can also be, or further include, special purpose logic circuitry, e.g., a central processing unit (CPU), a GPU (a graphics processing unit); a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them.

The computing device 80 may comprise an input/output module 102, to which an input device, such as a keypad, keyboard, touch screen, microphone, speech recognition device, other devices that can accept user information, and/or an output device that conveys information associated with the operation of the computing device 80, including digital data, visual and/or audio information, or a GUI.

The computing device 80 can serve as a client, network component, a server, a database, or other persistency, and/or any other component. In some implementations, one or more components of the computing device 80 may be configured to operate within a cloud-computing-based environment or a distributed computing environment, such as servers 202. The database may include, for example, Oracle™ database, Sybase™ database, or other relational databases or non relational databases, such as Hadoop™ sequence files, HBase™, or Cassandra™. In one example, the database may include computing components (e.g., database management system, database server, etc.) configured to receive and process requests for data stored in memory devices of the database and to provide data from the database.

At a high level, the computing device 80 is an electronic computing device operable to receive, transmit, process, store, or manage data and information. According to some implementations, the computing device 80 may also include, or be communicably coupled with, an application server, e-mail server, web server, caching server, streaming data server, business intelligence (BI) server, and/or other server.

The computing device 80 may receive requests over network 200 from a client application (e.g., executing on another computing device 80) and respond to the received requests by processing said requests in an appropriate software application. In addition, requests may also be sent to the computing device 80 from internal users (e.g., from a command console or by another appropriate access method), external or third parties, other automated applications, as well as any other appropriate entities, individuals, systems, or computers. The application software may be configured to recognize multiple Computer Aided Design (CAD) file types including .STL, .WAV, .3MF, .AMF, .DXF, .IGES, .ISFF, and may grow to support file types such as .CGR, .CKD, .CKT, .EASM, .EDRW, .IAM, .JDW, .PAR, .PRT, .SKP, .SLDAS M, .SLDDRW, .SLDPRT, .TCT, .WRL, X_B, X_T and .XE depending on third party integration and support.

Computing device 80 includes an interface, as part of the I/O module 102, used according to particular needs, desires, or particular implementations of the computing device 80. The interface is used by computing device 80 for communicating with other systems in a distributed environment, connected to network 200. Generally, the interface comprises logic encoded in software and/or hardware in a suitable combination and operable to communicate with the network 200. More specifically, the interface may comprise software supporting one or more communication protocols associated with communications.

Although single processor 90 is illustrated in FIG. 8, two or more processors may be used according to particular needs, desires, or particular implementations of the computing device 80. Generally, processor 90 executes instructions and manipulates data to perform the operations of the computing device 80. In one example, processor 90 comprises a GPU implemented to speed up Radon transform calculation and ramp filtering of projections for the entire object.

Memory 100 stores data for computing device 80 and/or other components of the system 30. Although illustrated as a single memory 100 in FIG. 8, two or more memories may be used according to particular needs, desires, or particular implementations of the computing device 80. While memory 100 is illustrated as an integral component of the computing device 80, in alternative implementations, memory 100 can be external to the computing device 80 and/or the system 30. For example, memory 100 comprises computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto-optical disks; and CD-ROM, DVD+/−R, DVD-RAM, DVD-ROM disks and Blu-ray disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

In one example, an application in memory 100 comprises an algorithmic instructions providing functionality according to particular needs, desires, or particular implementations of the computing device 80, particularly with respect to functionality required for processing simulations and modelling calculations for distortion correction and correction for non-telecentricity. In addition, although illustrated as integral to the computing device 80, in alternative implementations, the application can be external to the computing device 80.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components, as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a GPU, an FPGA, or an ASIC.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network 200. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations, and free-space optical networks. The network may communicate with, for example, Internet Protocol (IP) packets, Frame Relay frames, Asynchronous Transfer Mode (ATM) cells, voice, video, data, and/or other suitable information between network addresses.

The computing system can include clients and servers and/or Internet-of-Things (IoT) devices running publisher/subscriber applications. A client and server are generally remote from each other and typically interact through a communication network. The relationship of client and server arises by virtue of computer programs running on the respective computers and having a client-server relationship to each other.

There may be any number of computers associated with, or external to, the system 30 and communicating over network 200. Further, the terms “client,” “user,” and other appropriate terminology may be used interchangeably, as appropriate, without departing from the scope of this disclosure. Moreover, this disclosure contemplates that many users may use one computing device 80, or that one user may use multiple computing device 80.

In another example, the light source 32 is a light emitting diode (LED) or an array of LEDs.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking and parallel processing may be advantageous.

Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Accordingly, the above description of example implementations does not define or constrain this disclosure. Other changes, substitutions, and alterations are also possible without departing from the spirit and scope of this disclosure.

The benefits and advantages described above may relate to one embodiment or may relate to several embodiments. The embodiments are not limited to those that solve any or all of the stated problems or those that have any or all of the stated benefits and advantages. The operations of the methods described herein may be carried out in any suitable order, or simultaneously where appropriate. Additionally, individual blocks may be added or deleted from any of the methods without departing from the spirit and scope of the subject matter described herein. Aspects of any of the examples described above may be combined with aspects of any of the other examples described to form further examples without losing the effect sought.

### References

1. J. R. Tumbleston, D. Shirvanyants, N. Ermoshkin, R. Janusziewicz, A. R. Johnson, D. Kelly, K. Chen, R. Pinschmidt, J. P. Rolland, and A. Ermoshkin, “Continuous liquid interface production of 3D objects,” Science 347(6228), 1349-1352 (2015).
2. M. Regehly, Y. Garmshausen, M. Reuter, N. F. König, E. Israel, D. P. Kelly, C.-Y. Chou, K. Koch, B. Asfari, and S. Hecht, “Xolography for linear volumetric 3D printing,” Nature 588(7839), 620-624 (2020).
3. M. P. de Beer, H. L. van der Laan, M. A. Cole, R. J. Whelan, M. A. Burns, and T. F. Scott, “Rapid, continuous additive manufacturing by volumetric polymerization inhibition patterning,” Sci. Adv.5(1), eaau8723 (2019).
4. M. Shusteff, A. E. M. Browar, B. E. Kelly, J. Henriksson, T. H. Weisgraber, R. M. Panas, N. X. Fang, and C. M. Spadaccini, “One-step volumetric additive manufacturing of complex polymer structures,” ci. Adv.3(12), eaao5496 (2017).
5. H. Cui, R. Hensleigh, D. Yao, D. Maurya, P. Kumar, M. G. Kang, S. Priya, and X. Rayne Zheng, “Three-dimensional printing of piezoelectric materials with designed anisotropy and directional response,” Nat. Mater. 18(3), 234-241 (2019).
6. B. Deore, K. L. Sampson, T. Lacelle, N. Kredentser, J. Lefebvre, L. S. Young, J. Hyland, R. E. Amaya, J. Tanha, P. R. L. Malenfant, H. W. de Haan, and C. Paquet, “Direct printing of functional 3D objects using polymerization-induced phase separation,” Nat. Commun. 12(1), 55 (2021).
7. D. A. Walker, J. L. Hedrick, and C. A. Mirkin, “Rapid, large-volume, thermally controlled 3D printing using a mobile liquid interface,” Science 366(6463), 360-364 (2019).
8. J. J. Schwartz and A. J. Boydston, “Multimaterial actinic spatial control 3D and 4D printing,” Nat. Commun.10(1), 791 (2019).
9. D. G. Moore, L. Barbera, K. Masania, and A. R. Studart, “Three-dimensional printing of multicomponent glasses using phase-separating resins,” Nat. Mater. 19(2), 212-217 (2020).
10. R. Hensleigh, H. Cui, Z. Xu, J. Massman, D. Yao, J. Berrigan, and X. Zheng, “Charge-programmed three-dimensional printing for multi-material electronic devices,” Nat. Electron.3, 216-224 (2020).
11. B. E. Kelly, I. Bhattacharya, H. Heidari, M. Shusteff, C. M. Spadaccini, and H. K. Taylor, “Volumetric additive manufacturing via tomographic reconstruction,” Science 363(6431), 1075-1079 (2019).
12. D. Loterie, P. Delrot, and C. Moser, “High-resolution tomographic volumetric additive manufacturing,” Nat. Commun. 11(1), 852 (2020).
13. P. N. Bernal, P. Delrot, D. Loterie, Y. Li, J. Malda, C. Moser, and R. Levato, “Volumetric bioprinting of complex living-tissue constructs within seconds,” Adv. Mater.31(42), 1904209 (2019).
14. M. Dawson-Haggerty, “Trimesh,” https: //github.com/mikedh/trimesh.
15. M. Weigert, “gputools: OpenCL accelerated volume processing,” https: //github.com/maweigert/gputools.
16. J. Nickolls, I. Buck, M. Garland, and K. Skadron, “Scalable parallel programming with CUDA,” Queue6(2), 40-53 (2008).

1. A method for additive manufacturing of an object having a three-dimensional structure formed from a photo-curable material, the method implemented by a computing device comprising a processor and a computer readable medium having instructions executable by the processor, the method comprising at least the steps of:
(a) rotating a vial containing the photo-curable material in a path of a light beam at a predefined rotation speed;
(b) calculating patterns associated with a 3D geometry of the object;
(c) modulating a focal length of the beam within the photo-curable material while projecting the beam comprising the patterns into the photo-curable material to form the object.

2. The method of claim 1, further comprising positioning an electrically addressable optical component in the path of the light beam, and modifying the electrically addressable optical component's focal length to achieve axial scanning of the object plane.

3. The method of claim 2, wherein the focal length is modified at a predefined frequency.

4. The method of claim 3, wherein the predefined frequency is greater than the predefined rotation speed of the vial.

5. The method of claim 3, wherein the patterns are projected at a predefined frame rate, and wherein a time-average beam within the photo-curable material is substantially collimated.

6. The method of claim 5, wherein the predefined frame rate of the patterns is equal to the predefined frequency.

7. The method of claim 6, wherein the electrically addressable optical component is an electrically tunable lens.

8. The method of claim 1, wherein the modulating step comprises oscillating the vial back and forth along an optical axis of the light beam.

9. The method of claim 8, wherein the beam within the photo-curable material is substantially collimated when averaged over one oscillation.

10. The method of claim 9, wherein the vial oscillates at a frequency greater than the predefined rotation speed of the vial.

11. The method of claim 10, wherein the patterns are projected at a predefined frame rate.

12. The method of claim 1, wherein the modulating step comprises oscillating a beam shaping optical component in the path of the light beam back and forth at a predefined oscillation frequency.

13. The method of claim 12, wherein the time-averaged beam within the photo-curable material is substantially collimated.

14. The method of claim 13, wherein the patterns are projected at a predefined frame rate.

15. The method of claim 14, wherein the predefined frame rate is equal to the predefined oscillation frequency of the beam shaping optical component.

16. The method of claim 1, wherein the modulating step comprises positioning an axicon along the beam's axis.

17. A system for additive manufacturing of an object having a three-dimensional structure formed from a photo-curable material, the system comprising:
a computing device comprising a processor and a computer readable medium having instructions executable by the processor, wherein the processor is caused to at least:
(a) rotate a stage supporting a vial containing the photo-curable material in a path of a light beam at a predefined rotation speed;
(b) modulate a focal length of the beam within the photo-curable material; and
(c) project patterns associated with a 3D geometry of the object into the photo-curable material to form the object.

18. The system of claim 17, wherein an electrically addressable optical component is positioned along the beam's axis, and the electrically addressable optical component is caused to modify its focal length to achieve axial scanning of the object plane.

19. The system of claim 18, wherein the electrically addressable optical component's focal length is modified at a predefined frequency.

20. The system of claim 19, wherein modulating electrically addressable optical component at the predefined frequency generates a substantially time-averaged collimated beam within the photo-curable material.

21. The system of claim 20, wherein the predefined frequency is greater than the predefined rotation speed of the vial.

22. The system of claim 21, wherein the patterns are projected at a predefined frame rate.

23. The system of claim 22, wherein the predefined frame rate of the projection patterns is equal to the predefined frequency of the electrically addressable optical component.

24. The system of claim 17, wherein the vial containing the photo-curable material is oscillated back and forth along an optical axis of the light beam at a predefined frequency to modulate the focal length of the beam.

25. The system of claim 24, wherein oscillating the vial containing the photo-curable material at the predefined oscillation frequency generates a substantially time-averaged collimated beam within the photo-curable material.

26. The system of claim 25, wherein the predefined oscillation frequency is greater than the predefined rotation speed of the vial.

27. The system of claim 26, wherein the patterns are projected at a predefined frame rate.

28. The system of claim 27, wherein the electrically addressable optical element is an electrically tunable lens.

29. The system of claim 28, wherein the predefined frame rate of the projection patterns is equal to the predefined frequency of the tunable lens.

30. The system of claim 17, wherein the modulating step comprises oscillating a beam shaping optical component in the path of the light beam back and forth at a predefined oscillation frequency.

31. The system of claim 30, wherein the time-averaged beam within the photo-curable material is substantially collimated.

32. The system of claim 31, wherein the patterns are projected at a predefined frame rate.

33. The system of claim 32, wherein the predefined frame rate is equal to the predefined oscillation frequency of the beam shaping optical component.

34. The system of claim 17, wherein an axicon positioned along the beam's axis generates a substantially collimated beam within the photo-curable material.
